(19) United States
(12) Patent Application Publication
(10) Pub. No.: US 2014/0361527 A1
(43) Pub. Date: Dec. 11, 2014

(54) METHOD OF FORMING A COLOR LASER IMAGE, AND RESULTING DOCUMENT

(71) Applicants: Jean Pierre Lazzari, Sainte Maxime (FR); Jean Marc Lazzari, Saint Remy l'Honore (FR)

(72) Inventors: Jean Pierre Lazzari, Sainte Maxime (FR); Jean Marc Lazzari, Saint Remy l'Honore (FR)

(21) Appl. No.: 14/367,013

(22) PCT Filed: Dec. 5, 2012
(86) PCT No.: PCT/FR2012/000501

§ 371 Date: Jun. 19, 2014

(30) Foreign Application Priority Data
Dec. 19, 2011 (FR) 11/03919

(51) Int. Cl. B42D 15/00; B41J 2/44

(52) U.S. Cl. CPC B42D 15/00; B41J 2/442
USPC 283/85; 347/224

(57) ABSTRACT

The present invention relates to a method of forming color laser images. The latent image made up or color subpixels (2) and of non-colored zones is personalized by a laser beam (8) that acts in the laserable layer (3) situated under the color subpixels (2) and the non-colored zones to cause a final personalized color laser image to appear. The invention is applicable to identity documents.

### FIELD OF APPLICATION OF THE INVENTION

The present invention relates to a method of forming color laser images. It finds applications in particular in identity images for identity documents identity cards, credit cards, health insurance cards, passports, drivers licenses, secure entry badges, etc.

### STATE OF THE PRIOR ART

Patent WO 2011/124774 A1 describes a method of personalizing embedded latent images for identity documents, including a latent image made up of a matrix of pixels constituted by color subpixels embedded in a transparent protection layer. With the help of a laser beam acting through the transparent protection layer, gray levels are created on the subpixels by covering they with a black non-reflecting surface, thereby creating the gray levels of the final color laser image. This treatment serves to personalize the latent image that is constituted by the color subpixels.

The image as personalized in this way is observed by reflection through the transparent protection layer. The personalized image must be sufficiently reflective to enable it to be observed in ambient light without having recourse to an additional light source.

Patent application No. 11/00578 describes a method of making a highly reflective laser image comprising a latent image made up of color subpixels surrounded by non-colored transparent zones and covered in a transparent protection layer that is sensitive to laser radiation, that is referred to below as the “laserable” layer. A laser beam causes non-reflecting black surfaces to appear in this laserable protection layer, which surfaces cover the surfaces of the color subpixels and subpixels and the non-colored surfaces to a greater or lesser extent for the purpose of imparting the gray levels of a personalized image. The personalized image is seen by reflection on underlying reflective sublayers, in particular white sublayers, or through varnish, in order to increase the reflectivity of the image. Image reflectivity is of fundamental importance since it must enable the eye to act by additive composition to integrate the light beams with the colors of the subpixels and from the non-colored zones, as emitted by back reflection of the incident light.

Although advantageous in some respects, those structures nevertheless put a limit on the quality of the personalized image. The non-reflecting black surfaces that form the gray levels of the personalized image are situated either on the subpixels, or above the subpixels of the latent image, and they form shadow effects that darken the final personalized image.

### SUMMARY OF THE INVENTION

An object of the present invention is to remedy the drawbacks of the prior art by improving the quality of the final personalized image. To do this, the invention proposes forming the non-reflecting surfaces that constitute the gray levels of the final personalized image under the latent image constituted by the color subpixels.

More precisely, the invention provides a method of forming personalized color laser images from an assembly comprising a transparent protection layer, a printed latent image constituted by color subpixels and by non-colored surfaces, a laserable layer under the latent image, reflective means, and a laser beam that passes through the protection layer, through the subpixels of the latent image, and the non-colored surfaces and forms the gray levels of a final personalized image in the laserable layer, the assembly being laminated on a medium.

The gray levels that lead to the latent image being personalized in order to form the final image are calculated with the help of software that takes an original image, segments it into subpixels, calculates the corresponding color shades, and determines the gray levels that are to be carbonized in the laserable layer under the color subpixels and the non-colored zones of the latent image in order to obtain the same color shades as those in the original image.

The gray levels of the personalized image are obtained by a degree of blackening that is made proportional to the energy deposited by the laser by means of linearizing software, known to the person skilled in the art, and also by varying the areas of the carbonization.

Furthermore, the energy of the laser beam is adjusted as a function of the colors of the subpixels, and of the non-colored zones through which it passes, since the required laser energy needs to be adjusted depending on Lbs colors of the subpixels and on the transparency of the non-colored zones.

By way of non-limiting example, the laserable materials that form the gray levels of the personalized image by being carbonized under the effect of a laser beam may be constituted by polycarbonates, certain treated polyvinyl chlorides, treated acrylonitrile-butadiene-styrenes, or treated polyethylene terephthalates.

In particular implementations of the invention;
the medium of the identity document is white in color, with surface doping, so as to be sensitive to the laser radiation for forming the gray levels of the personalized image, with the latent image constituted by color subpixels and by non-colored zones being printed on that surface;
the color subpixels of the latent image are printed on the surface of the protection layer that is to be laminated on the laserable layer;
the laserable layer is transparent. It is laminated onto a reflective surface that may advantageously be constituted by the body of the document that is white in color;
the body of the document is transparent; and
the protection layer is hot-pressed during lamination in order to form a lens array.

The thickness of the laserable layer or the thickness of the doped portion of the document medium should be as thin as possible, while being compatible with the required gray levels. This thickness may advantageously lie in the range a few micrometers to about one hundred micrometers.

The color subpixels are printed by offset printing, ink-jet printing, or any other technique known to the person skilled in the art. Non-colored zones or non-colored subpixels serve to increase the reflectivity of the final image The color subpixels and the non-colored zones are organized in parallel columns or in small areas that are uniformly distributed. The latent image may be constituted by triplets or quadruplets of color subpixels. The colors of the subpixels are preferably selected from colors that are independent, i.e. mixing any two of them cannot lead to a third subpixel color being formed. These colors include red, green, and blue, or yellow, magenta, and cyan.

In the second fabrication step, referred to as “laminating”, the protection layer and the layer of laserable material are bonded hot under pressure, onto the body of the identity document, thereby embedding the matrix of color subpixels and of non-colored zones between the protection layer and the layer of laserable material.

In another variant of the invention, during lamination, the protection layer may be molded to give it specific shapes, such as a lens array, enabling the laser beam at particular angles of incidence to etch under the latent image so as to personalize a plurality of distinct color laser images.

The laser carbonization that causes the gray levels to appear obstructs incident light to a greater or lesser extent and also the reflected light that passes through the color subpixels and the non-colored zones of the latent image, thereby limiting interfering reflections and shadowing effects that might obscure the final personalized image.

The invention also provides a document including a personalized laser image made by performing the above method.

This document comprises a transparent protection sheet, a latent image constituted by an array of color subpixels and of non-colored zones, a layer of laserable material situated under the latent image, said sheet being carbonized in at least in part by laser radiation, and a document medium. The protection sheet, the latent image, the laserable layer, and the medium are suitable for being laminated together.

In particular embodiments
the laserable layer is obtained by surface doping the white-colored body of the document, the latent image constituted by color subpixels and non-colored zones is printed on the doped surface of the body of the document;
the subpixels of the latent image are printed on the surface of the protection layer that is to he laminated on the laserable layer;
the laserable layer is transparent. It is laminated on the reflective surface that may advantageously be constituted by the white-colored body of the document;
the body of the document is transparent; and
the protection layer is hot-formed during lamination to give it the form of a lens array enabling the laser to etch a plurality of distinct personalized color laser images on the latent image.

### DESCRIPTION OF THE FIGURES

The invention appears better from the following description given by way of non-limiting explanation. The description refers to the accompanying drawings, in which:

FIG. 1 is a section view of a prior art identity document including a color laser image;

FIG. 2 is a section view of a first document of the invention;

FIG. 3 is a section view of a second embodiment of the invention; and

FIG. 4 is a section view of a third embodiment of the invention.

### DETAILED DESCRIPTION

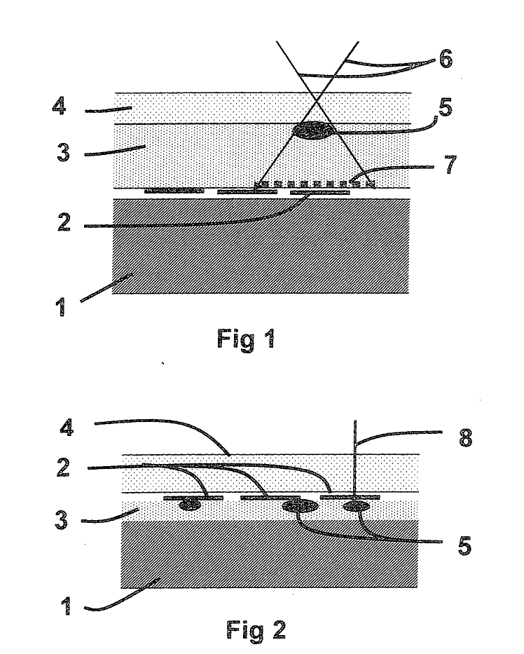

FIG. 1 is a section view of a prior art identity document including a color laser image. The transparent protection layer (4), the laserable layer (3), and the matrix of subpixels are laminated on the body of the identity document (1). The black surface (5) produced by carbonization by means of the laser beam is situated vertically in register with the color subpixel (2) of the latent image. If incident ambient light rays (6) are not accurately perpendicular to the plane of the document, then the shadow cast by the black surface (5) on the color subpixels (2) overflows considerably from the area of the subpixel creating a shadow zone (7) that darkens the personalized image.

FIG. 2 is a section of a first embodiment of the invention. The body (1) of the identity document is white. It is doped on the surface so as to create a laserable layer (3). The latent image comprising the color subpixels (2) and the non-colored zones is printed on this layer (3). Alternatively, it may be printed on the transparent protection layer (4). The protection layer (4) is laminated onto the assembly. The laser beam (8) forms the gray levels (5) of the final personalized image in the laserable layer (3). No shadow zone appears in the invention.

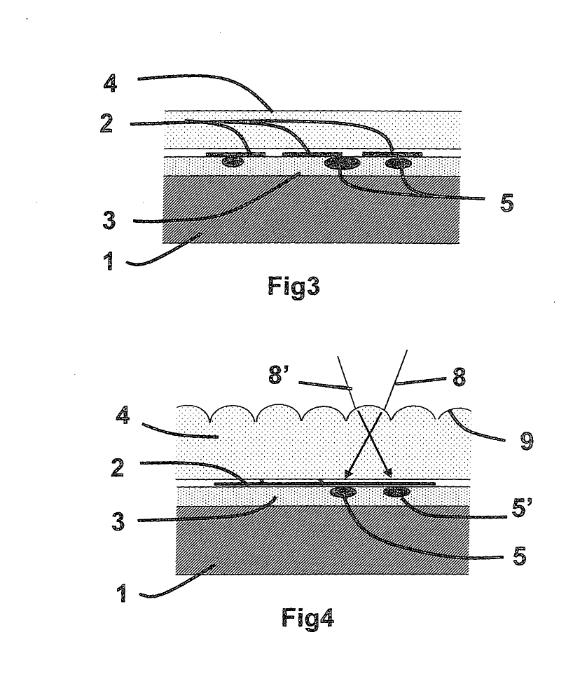

FIG. 3 is a section of a second embodiment of the invention. A layer of laserable material (3) is laminated on the card body (1). The color subpixels (2) are printed on this laserable layer (3) together with non-colored zones, the assembly constituting the latent Image. Alternatively, the color subpixels (2) may be printed on the protection layer. The protection layer (4) is then laminated on the assembly.

FIG. 4 is a section of a third embodiment of the invention. The laserable layer (3) is obtained on the card body (1) by surface doping the card body (1). In a variant, this laserable layer (3) is laminated on the card body (1). The latent image (2) including the color subpixels and the non-colored zones is printed on the laserable layer (3). Alternatively, the latent image may be printed on the protection layer (4). The protection layer (4) is laminated on the preceding assembly. During lamination, its top surface seen from beside the observer is hot-pressed so as to form a lens array (9). Since the laser rays (8) and (8′) have a certain angle of incidence relative to the plane of the document, they act by carbonization in the laserable layer (3) to form two distinct personalized images (5) and (5′) under the color subpixels (2) of the latent image. These two color laser images are viewed separately by back reflection of the incident light. In an alternative, three personalized laser images are made.

1. A method of forming personalized color laser images from an assembly comprising a transparent protection layer, a printed latent image constituted by color subpixels and by non-colored surfaces, a laserable layer under the latent image, reflective means, and a laser beam that passes through the protection layer, through the subpixels of the latent image, and the non-colored surfaces, and forms the gay levels of a final personalized image in the laserable layer, the assembly being laminated on a medium.

2. A method of forming personalized color laser images according to claim 1, wherein the laserable layer (3) is obtained by surface doping the card body (1).

3. A method of forming personalized color laser images according to claim 1, wherein the laserable layer (3) is laminated on the card body (1).

4. A method of forming personalized color laser images according to claim 1, wherein the latent image comprising the subpixels (2) and the non-colored zones is printed on the surface of the laserable layer (3).

5. A method of forming personalized color laser images according to claim 1, wherein the top face of the protection layer (4) is hot-pressed to form a lens array (9) enabling a plurality of distinct personalized color laser images to be etched.

6. A document including personalized color laser images made by performing the method according to claim 1, the document being characterized in that it includes a transparent protection sheet, a latent image constituted by an array of color subpixels and of non-colored zones, a layer of laserable material situated under the latent image, said sheet being carbonized at least in part by laser radiation, and a document medium. The protection sheet, the latent image, the laserable layer, and the medium are suitable for being laminated together.

7. A document according to claim 6, wherein the protection layer (4) forms a lens array (9) on its surface.

8. A document according to claim 6, wherein the document body (1) is white.

9. A document according to claim 6, wherein the document body (1) is transparent.
